(19) United States
(12) Patent Application Publication
(10) Pub. No.: US 2025/0247720 A1
(43) Pub. Date: Jul. 31, 2025

(54) USER EQUIPMENT MACHINE LEARNING ACTION DECISION AND EVALUATION

(71) Applicant: Nokia Technologies Oy, Espoo (FI)

(72) Inventors: István Zsolt KOVÁCS, Aalborg (DK); Jian SONG, Massy (FR); Muhammad Majid BUTT, Naperville, IL (US); Klaus Ingemann PEDERSEN, Aalborg (DK); Hans Thomas HÖHNE, Espoo (FI); Teemu Mikael VEIJALAINEN, Espoo (FI); Oana-Elena BARBU, Aalborg (DK); Luis Guilherme UZEDA GARCIA, Massy (FR)

(21) Appl. No.: 18/855,868

(22) PCT Filed: Apr. 12, 2022
(86) PCT No.: PCT/EP2022/059725

§ 371 Date: Oct. 10, 2024

(51) Int. Cl. H04W 24/02; H04L 41/16

(52) U.S. Cl. CPC H04W 24/02; H04L 41/16

(57) ABSTRACT

Techniques of implementing actions in a wireless network based on machine learning process output include a user equipment (UE) that runs a machine learning process communicating to a network node (gNB) an action to be taken based on an output of the machine learning process.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHZ).

### SUMMARY

According to an example implementation, a method includes performing, by a user equipment in a wireless network, at least one machine learning process to produce an output. The method also includes determining, by the user equipment, an action to perform based on the output produced by the performing of the at least one machine learning process. The method further includes transmitting, by a user equipment in a wireless network to a network node serving the user equipment, a request to perform the action. The method further includes receiving, by the user equipment from the network node, a message indicating whether the user equipment may perform the action. The method further includes, in response to the message indicating the user equipment may perform the action, performing, by the user equipment, the action. The method further includes, in response to the message indicating the user equipment may not perform the action, not performing the action.

According to an example implementation, an apparatus includes at least one processor and at least one memory including computer program code, the at least one memory and the computer program code configured to, with the at least one processor, cause the apparatus at least to perform, by a user equipment in a wireless network, at least one machine learning process to produce an output. The at least one memory and the computer program code are also configured to, with the at least one processor, cause the apparatus at least to determine, by the user equipment, an action to perform based on the output produced by the performing of the at least one machine learning process. The at least one memory and the computer program code are further configured to, with the at least one processor, cause the apparatus at least to transmit, by a user equipment in a wireless network to a network node serving the user equipment, a request to perform the action. The at least one memory and the computer program code are further configured to, with the at least one processor, cause the apparatus at least to receive, by the user equipment from the network node, a message indicating whether the user equipment may perform the action. The at least one memory and the computer program code are further configured to, with the at least one processor, cause the apparatus at least to, in response to the message indicating the user equipment may perform the action, perform, by the user equipment, the action. The at least one memory and the computer program code are further configured to, with the at least one processor, cause the apparatus at least to, in response to the message indicating the user equipment may not perform the action, not perform the action.

According to an example implementation, an apparatus includes means for performing, by a user equipment in a wireless network, at least one machine learning process to produce an output. The apparatus also includes means for determining, by the user equipment, an action to perform based on the output produced by the performing of the at least one machine learning process. The apparatus further includes means for transmitting, by a user equipment in a wireless network to a network node serving the user equipment, a request to perform the action. The apparatus further includes means for receiving, by the user equipment from the network node, a message indicating whether the user equipment may perform the action. The apparatus further includes means for, in response to the message indicating the user equipment may perform the action, performing, by the user equipment, the action. The apparatus further includes means for, in response to the message indicating the user equipment may not perform the action, not performing the action.

According to an example implementation, a computer program product includes a computer-readable storage medium and storing executable code that, when executed by at least one data processing apparatus, is configured to cause the at least one data processing apparatus to perform, by a user equipment in a wireless network, at least one machine learning process to produce an output. The computer-readable storage medium also stores executable code that, when executed by at least one data processing apparatus, is configured to cause the at least one data processing apparatus to determine, by the user equipment, an action to perform based on the output produced by the performing of the at least one machine learning process. The computer-readable storage medium further stores executable code that, when executed by at least one data processing apparatus, is configured to cause the at least one data processing apparatus to transmit, by a user equipment in a wireless network to a network node serving the user equipment, a request to perform the action. The computer-readable storage medium further stores executable code that, when executed by at least one data processing apparatus, is configured to cause the at least one data processing apparatus to receive, by the user equipment from the network node, a message indicating whether the user equipment may perform the action. The computer-readable storage medium further stores executable code that, when executed by at least one data processing apparatus, is configured to cause the at least one data processing apparatus to, in response to the message indicating the user equipment may perform the action, perform, by the user equipment, the action. The computer-readable storage medium further stores executable code that, when executed by at least one data processing apparatus, is configured to cause the at least one data processing apparatus to, in response to the message indicating the user equipment may not perform the action, not perform the action.

According to an example implementation, a method includes receiving, by a network node of a wireless network from a user equipment, the network node serving a user equipment in the wireless network, a request for an action, determined by the user equipment based on an output of at least one machine learning process, to be performed by the user equipment. The method also includes, generating, by the network node, a respective prediction of an outcome of a performance of the action by the user equipment on the wireless network. The method further includes transmitting, by the network node to the user equipment, a message indicating whether the user equipment may perform the action based on the respective prediction.

According to an example implementation, an apparatus includes at least one processor and at least one memory including computer program code, the at least one memory and the computer program code configured to, with the at least one processor, cause the apparatus at least to receive, by a network node of a wireless network from a user equipment, the network node serving a user equipment in the wireless network, a request for an action, determined by the user equipment based on an output of at least one machine learning process, to be performed by the user equipment. The at least one memory and the computer program code are also configured to generate, by the network node, a respective prediction of an outcome of a performance of the action by the user equipment on the wireless network. The at least one memory and the computer program code are further configured to transmit, by the network node to the user equipment, a message indicating whether the user equipment may perform the action based on the respective prediction.

According to an example implementation, an apparatus includes means for receiving, by a network node of a wireless network from a user equipment, the network node serving a user equipment in the wireless network, a request for an action, determined by the user equipment based on an output of at least one machine learning process, to be performed by the user equipment. The apparatus also includes means for generating, by the network node, a respective prediction of an outcome of a performance of the action by the user equipment on the wireless network. The apparatus further includes means for transmitting, by the network node to the user equipment, a message indicating whether the user equipment may perform the action based on the respective prediction.

According to an example implementation, a computer program product includes a computer-readable storage medium and storing executable code that, when executed by at least one data processing apparatus, is configured to receive, by a network node of a wireless network from a user equipment, the network node serving a user equipment in the wireless network, a request for an action, determined by the user equipment based on an output of at least one machine learning process, to be performed by the user equipment. The executable code, when executed by at least one data processing apparatus, is also configured to cause the at least one data processing apparatus to generate, by the network node, a respective prediction of an outcome of a performance of the action by the user equipment on the wireless network. The executable code, when executed by at least one data processing apparatus, is further configured to cause the at least one data processing apparatus to transmit, by the network node to the user equipment, a message indicating whether the user equipment may perform the action based on the respective prediction.

According to an example implementation, a method includes performing, by a user equipment in a wireless network, at least one machine learning process to produce an output. The method also includes determining, by the user equipment, an action to perform based on the output produced by the performing of the at least one machine learning process. The method further includes performing, by the user equipment, the action to produce a performance of the action. The method further includes transmitting, by the user equipment to the network node, a first message including an indication of an estimated local outcome of the performance of the action. The method further includes receiving, by the user equipment from the network node, a second message indicating an effect of the action on the wireless network globally.

According to an example implementation, an apparatus includes at least one processor and at least one memory including computer program code, the at least one memory and the computer program code configured to, with the at least one processor, cause the apparatus at least to perform, by a user equipment in a wireless network, at least one machine learning process to produce an output. The at least one memory and the computer program code are also configured to determine, by the user equipment, an action to perform based on the output produced by the performing of the at least one machine learning process. The at least one memory and the computer program code are further configured to perform, by the user equipment, the action to produce a performance of the action. The at least one memory and the computer program code are further configured to transmit, by the user equipment to the network node, a first message including an indication of an estimated local outcome of the performance of the action. The at least one memory and the computer program code are further configured to receive, by the user equipment from the network node, a second message indicating an effect of the performance of the action on the wireless network globally.

According to an example implementation, an apparatus includes means for performing, by a user equipment in a wireless network, at least one machine learning process to produce an output. The apparatus also includes means for determining, by the user equipment, an action to perform based on the output produced by the performing of the at least one machine learning process. The apparatus further includes means for performing, by the user equipment, the action to produce a performance of the action. The apparatus further includes means for transmitting, by the user equipment to the network node, a first message including an indication of an estimated local outcome of the performance of the action. The apparatus further includes means for receiving, by the user equipment from the network node, a second message indicating an effect of the action on the wireless network globally.

According to an example implementation, a computer program product includes a computer-readable storage medium and storing executable code that, when executed by at least one data processing apparatus, is configured to perform, by a user equipment in a wireless network, at least one machine learning process to produce an output. The executable code, when executed by at least one data processing apparatus, is also configured to determine, by the user equipment, an action to perform based on the output produced by the performing of the at least one machine learning process. The executable code, when executed by at least one data processing apparatus, is further configured to perform, by the user equipment, the action to produce a performance of the action. The executable code, when executed by at least one data processing apparatus, is further configured to transmit, by the user equipment to the network node, a first message including an indication of an estimated local outcome of the performance of the action. The executable code, when executed by at least one data processing apparatus, is further configured to receive, by the user equipment from the network node, a second message indicating an effect of the performance of the action on the wireless network globally.

According to an example implementation, a method includes receiving, by a network node of a wireless network from a user equipment, the network node serving a user equipment in the wireless network, a first message indicating that the user equipment has performed an action to produce a performance of the action, the action being determined based on output of a machine learning process, the first message also indicating an estimated local outcome of the performance of the action. The method also includes generating, by the network node, a respective prediction of a global outcome of the performance of the action by the user equipment on the wireless network. The method further includes transmitting, by the network node to the user equipment, a second message indicating whether the user equipment should continue to perform the action based on the prediction of the global outcome of the performance of the action by the user equipment on the wireless network.

According to an example implementation, an apparatus includes at least one processor and at least one memory including computer program code, the at least one memory and the computer program code configured to, with the at least one processor, cause the apparatus at least to receive, by a network node of a wireless network from a user equipment, the network node serving a user equipment in the wireless network, a first message indicating that the user equipment has performed an action to produce a performance of the action, the action being determined based on output of a machine learning process, the first message also indicating an estimated local outcome of the performance of the action. The at least one memory and the computer program code are also configured to generate, by the network node, a respective prediction of a global outcome of the performance of the action by the user equipment on the wireless network. The at least one memory and the computer program code are further configured to transmit, by the network node to the user equipment, a second message indicating whether the user equipment should continue to perform the action based on the prediction of the global outcome of the performance of the action by the user equipment on the wireless network.

According to an example implementation, an apparatus includes means for receiving, by a network node of a wireless network from a user equipment, the network node serving a user equipment in the wireless network, a first message indicating that the user equipment has performed an action to produce a performance of the action, the action being determined based on output of a machine learning process, the first message also indicating an estimated local outcome of the performance of the action. The apparatus also includes means for generating, by the network node, a respective prediction of a global outcome of the performance of the action by the user equipment on the wireless network. The apparatus further includes means for transmitting, by the network node to the user equipment, a second message indicating whether the user equipment should continue to perform the action based on the prediction of the global outcome of the performance of the action by the user equipment on the wireless network.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a sequence diagram illustrating a process of determining action to take upon execution of a machine learning algorithm, according to an example implementation.

FIG. 3 is a sequence diagram illustrating a process of determining action to take upon execution of machine learning algorithms, according to an example implementation.

FIG. 4 is a sequence diagram illustrating a process of determining action to take upon execution of a machine learning algorithm, according to an example implementation.

FIG. 5 is a flow chart illustrating a process of determining action to take upon execution of a machine learning algorithm, according to an example implementation.

FIG. 6 is a flow chart illustrating a process of determining action to take upon execution of a machine learning algorithm, according to an example implementation.

FIG. 7 is a flow chart illustrating a process of determining action to take upon execution of a machine learning algorithm, according to an example implementation.

FIG. 8 is a flow chart illustrating a process of determining action to take upon execution of a machine learning algorithm, according to an example implementation.

FIG. 9 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

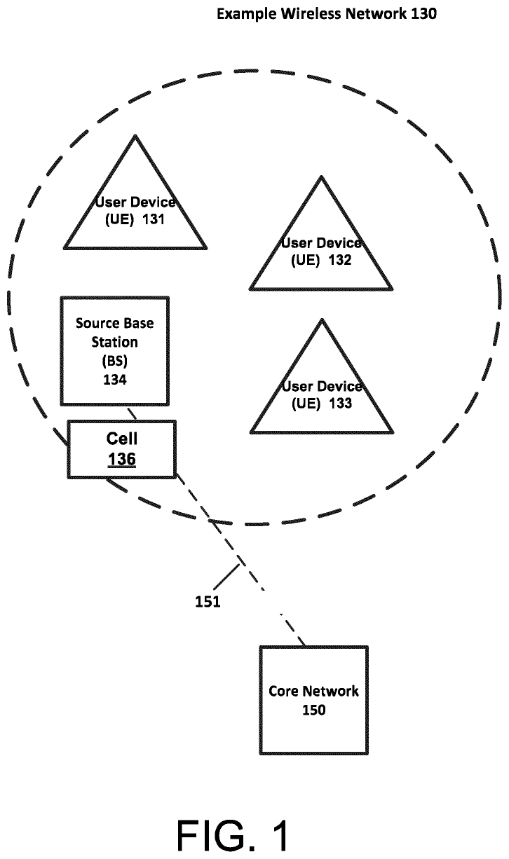

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) also may be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

Some radio resource management (RRM) functionalities in the UE can be supported/driven by machine learning (ML)-based algorithms (i.e., combination of ML and rule-based algorithms) the majority of which will likely be device or network vendor specific. Nevertheless, the use of ML-based algorithms might have impact on the performance of the RRM functionality, e.g., in the UE for antenna panel or beam control, RRM measurements and feedback (channel state information (CSI) feedback), link monitoring, Transmit Power Control (TPC). In some cases, this impact may be mostly positive and is reflected in performance gains in various traditional key performance indicators (KPIs), which are also observable at the NG-RAN level.

Accordingly, it is desirable to allow the NG-RAN to take advantage of these potential performance gains in a ‘proactive’ manner, i.e., beyond just simply taking note that certain UEs perform better than others.

Conventional techniques of implementing ML-based actions have signaling protocols between the gNB and UE that may need to be extended to include new information elements and procedures which are specifically designed for ML-based functionalities (executed at UE and/or gNB side). Such new information elements and procedures may allow for a more dynamic selection and configuration of the ML-based functionalities available in the UE, and the optimal UE reporting of the corresponding ML-specific inference/assistance output.

This may be illustrated with some concrete problems identified as follows:
Assumption: Existence of one or more ML-based algorithms implemented at UE side for inference and/or training, including exploration, etc. The ML agent acts based mostly on radio and traffic information available at the UE.
   “ML-action” refers to any UE ML-based radio parameter change or adjustment as a result of running an ML-based algorithm. The outcome of the action can remain local to the UE or it can be reported to the serving gNB.
   The UE ML algorithms can potentially also use information from the network conveyed at slower rate at higher layers (RRC or higher).
Problem #1: One UE's “action” does not create too much impact to the general cell performance, but many different actions from different UEs with “selfish behaviour” might cause problems.
Problem #2: The network may not know the best/optimal radio parameter configuration for each UE, as it has only delayed (past) information on their radio and traffic conditions.

In contrast to the conventional approach to implementing ML-based actions, improved techniques include a user equipment (UE) that runs a machine learning process communicating to a network node (gNB) an action to be taken based on an output of the machine learning process. For example, an objective within a wireless network may be to optimize a transmit power value per UE such that uplink (UL) and sidelink UE-side throughput is maximized with a minimum of impact on an overall UL cell performance. After exchanging configuration information with the gNB, the UE runs a reinforcement learning (RL)-based algorithm using as input UE local reference signal received power (RSRP) and antenna panel or beam selection information. The output of the RL-based algorithm is one of three action identifiers: “POWER INCREASE 1 DB,” “POWER DECREASE 1 DB,” and “NO POWER ADJUSTMENT,” with respective identifiers ID=0, 1, and 2. Based on the output, the UE determines an action, e.g., a suitable UL power adjustment and informs the gNB without performing the action. The gNB analyses this proposed UL power adjustment for the UE in the context of other UEs served by the gNB in the cell. If the gNB does not anticipate the proposed UL power adjustment will be detrimental to the cell UL performance, then the gNB sends an ACK message indicating that the UE may perform the action. If the gNB anticipates a performance degradation, however, the gNB sends a NACK message indicating that the UE should not perform the action.

It is noted that a machine learning process denotes the running or performing of a machine learning algorithm that maps inputs to outputs. For example, a machine learning process may generate UE UL (or sidelink) transmit power as an output based on input local radio conditions. That is, an output produced by a machine learning process is the result of running or performing the machine learning process on inputs.

It is also noted that the UE is configured to determine an action based on an output produced by performing the machine learning process. For example, an action to take as a result of the above-described machine learning process is to adjust the UL/sidelink transmit power. For example, when the machine learning process is performed by the UE, the output may be one of three possible actions: ‘Power increase 1 dB,’ ‘Power decrease 1 dB,’ ‘No Power adjustment.’ (In this case, the machine learning algorithm may be a classifier.) Thus, the action determined by the output of performing the machine learning process, the UE may either transmit a message to a serving gNB of the action about to be taken, or perform the action and then transmit a message to the gNB estimating an outcome of performing the action.

In some implementations, the UE does not propose an action to the gNB before performing the action. Rather, in such an embodiment, the UE performs the action and then informs the serving gNB about the action it took. In this case, the gNB stores information about the action and estimates its potential impact on the cell UL performance. If the potential impact is not detrimental, then the gNB sends the UE an ACK message indicating that the UE may continue to perform the action; otherwise, the gNB sends the UE a NACK message requesting the UE to stop performing the action.

The above-described improved technique for implementing ML-based actions has advantages over the conventional approaches, such as providing a level of control to the gNB over machine leaning-based actions without knowing the exact machine learning implementation in the UE.

As described above, the improved signaling flow may be used in two main scenarios described below. The proposed solutions may rely on an a priori ML capability exchange between the serving gNB and UE including potentially also some configuration parameters.

In the first scenario, the UE requests permission from the serving gNB to execute the selected action and potentially also indicates its estimated outcome:
1. The UE and gNB exchange information regarding capability for ML-based radio algorithms.
   a. The UE requests one or more ML-action related signaling configurations from the gNB to be used during the performance of one or more ML-based algorithms.
      i. RRC signaling is used to transmit the request.
   b. The UE receives the ML-action related signaling configuration(s) from the gNB, implicitly indicating the acknowledgment that the UE can start using the corresponding ML-based algorithm(s) to take actions (e.g., radio parameter setting).
      i. RRC signaling is used to transmit the ML-action related signaling configuration(s).
2. The UE activates the ML-based algorithm(s).
3. The UE determines an action to be executed as the outcome of an active ML-based algorithm.
4. The UE sends an “ML Action Request” message to the serving gNB.
   a. RRC or MAC signaling is used, depending on the time constrains of the action execution.
5. The gNB evaluates the potential outcome of the requested action taking into consideration any of the following: the available action requests/executions from other served UEs, the QoS requirements, traffic conditions (load), UE radio/RF capabilities, etc.
   a. If, upon evaluation, the requested action is determined to not have any detrimental impact on selected network KPIs (e.g., cell throughput degradation, increase physical resource block (PRB) utilization, then the gNB sends an “ML Action ACK” message to the UE.
   b. Else, the gNB sends “ML Action NACK” message to the UE.
   c. RRC or MAC signaling is used, depending on the time constrains of the action execution.
6. The UE which receives the ML Action ACK″ message from its serving gNB, performs the action. The UE which receives the ML Action NACK″ message from its serving gNB, does not perform the action.
   a. In some implementations, the UE sends an “ML Action Outcome Indicator” message to the serving gNB to indicate the estimated local outcome of taking, or not taking, this action.
      i. RRC signaling is used to transmit the message.
   b. In some implementations, the gNB receiving an “ML Action Outcome Indicator” message stores the indicated impact and potentially also evaluates a global impact factor taking in consideration the available action indicators from other served UEs.

In the second scenario, the UE indicates to the serving gNB the executed action and its potential estimated outcome.
1. The UE and gNB exchange information regarding capability for ML-based radio algorithms.
   a. The UE requests one or more ML-action related signaling configurations from the gNB to be used during the performance of one or more ML-based algorithms.
      i. RRC signaling is used to transmit the request.
   b. The UE receives the ML-action related signaling configuration(s) from the gNB, implicitly indicating the acknowledgment that the UE can start using the corresponding ML-based algorithm(s) to take actions (e.g., radio parameter setting).
      i. RRC signaling is used to transmit the ML-action related signaling configuration(s).
2. The UE activates the ML-based algorithm(s).
3. The UE determines an action to be executed as the outcome of an active ML-based algorithm.
4. The UE performs the action without input from the gNB.
5. The UE sends an “ML Action Outcome Indicator” message to the serving gNB to indicate the estimated local outcome of taking this action.
6. The gNB evaluates the outcome of the UE ML action taking in consideration the available actions requests/executions from other served UEs, the QoS requirements, traffic conditions (load), UE radio/RF capabilities, etc.
7. The gNB sends a “ML Action ACK/NACK” message to the UE indicating (at least) to Continue (ACK) or to Stop (NACK) taking these actions.
   a. RRC signaling is used.
8. The UE which receives the “ML Action ACK/NACK” message from its serving gNB, will (at least) Continue (ACK) or Stop (NACK) taking these actions.

It is noted that the above first and second scenarios specify new signaling elements (RRC, MAC) and new UE configuration structures. Also, the second scenario allows for a faster response than the first scenario but is less conservative regarding network control.

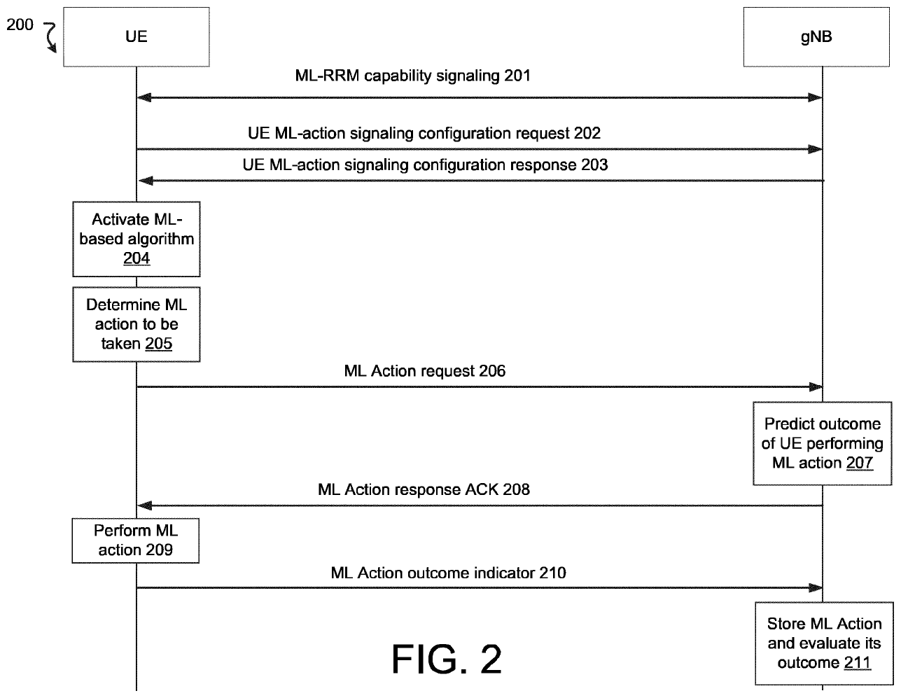

FIG. 2 is a sequence diagram illustrating a process 200 of determining action to take upon execution of a machine learning algorithm, corresponding to the first scenario described above.

At 201, in some implementations, the gNB and UE are exchanging messages regarding machine learning radio resource management (RRM) capability signaling.

At 202 the UE requests one or more signaling configurations from the gNB to be used during the execution of one or more ML-based algorithms.
RRC signaling is used.
   After the UE has transitioned from IDLE to CONNECTED mode, in case the UE ML-based algorithm is applied in CONNECTED mode, or
   Before the UE transitioning to IDLE/INACTIVE mode, in case the UE ML-based algorithm is applied in IDLE/INACTIVE mode.
The signaling configuration information indicates for each requested ML-based algorithm, at least the following.
   a ML-based algorithm ID—to be used by the gNB when aggregating information from several UEs and when sending ACK/NACK messages.
      This ID can be an ID of the ML-based algorithm/functionality e.g., HO, beam-selection, PC, etc.
      In some implementations, this ID can also include a version number for a continuously updated model as for federated learning solutions.
      In some implementations, the algorithm ID may designate the range of outputs (and potentially inputs) of the ML algorithm, without disclosing any implementation details.
   selection between the “UE request action permission” or “UE sends action indicator” (i.e., first and second scenarios)—the same ML-based algorithm could be configured for both procedures (different IDs) to allow potential switching at the request of the gNB,
   the signaling channel to be used, or protocol layer to be used e.g., RRC or MAC is selected depending on the time constrains of the action execution, and the expected parameters to be configured (information element IDs, accepted range of values, etc.).
   the set of ML Action IDs, to be used on the configured signaling channels.
   the set of ML Action Outcome IDs corresponding to at least one UE KPI which the UE uses to evaluate the local impact of the ML-based actions e.g., throughput target, throughput with delay constrains, spectral efficiency, energy consumption, etc.

At 203, the UE receives the signaling configuration(s) from the gNB, implicitly indicating the acknowledgment that the UE can start using the corresponding ML-based algorithm(s) to take actions e.g., a radio parameter setting.
RRC signaling is used.
   After the UE has transitioned from IDLE to CONNECTED mode, in case the ML-based algorithm is applied in CONNECTED mode, or
   Before the UE transitioning to IDLE/INACTIVE mode, in case the ML-based algorithm is applied in IDLE/INACTIVE mode.
The UE may apply the received configurations and disable all other ML-based algorithms for which it did not request or receive a configuration.
The configuration message can include a different evaluation KPI than requested by the UE.

At 204, the UE activates the ML algorithm, which produces an output.

At 205, the UE determines an action to be taken based on the output.

At 206, the UE sends a “ML Action Request” message to the serving gNB.
RRC or MAC signaling is used as configured in 202 and 203.
The message includes at least the following.
   The ML-based algorithm ID from 202.
   The selected action (e.g., increase or decrease of TX power, UE beam selection, etc.) and associated ID.
In some implementations, the UE sends an ordered list of preferred actions, leaving it up to the gNB to select the best action with regard to network KPI performance.
In some implementations, the ML architecture can be split between the UE and gNB and trained jointly, in that case, some partial outcomes would be sent from the UE to the gNB, the latter being ultimately in charge of generating the best action for each UE.

At 207, the gNB evaluates the potential outcome of the requested action taking in consideration the available actions requests/executions from other served UEs, the QoS requirements, traffic conditions (load), UE radio/RF capabilities, etc.
This is understood as ‘admission control’ for UE ML-based actions.
Historical data might be used at gNB side as the labelled data for training and testing.

At 208, the UE receives a “ML Action Response ACK” message, if the requested action is evaluated by the gNB to not have any detrimental impact on selected network KPIs (e.g., cell throughput degradation, increase PRB utilisation—can be different from the UE KPIs selected above) then, gNB sends a “ML Action ACK” message to the UE. Otherwise the gNB sends a “ML Action NACK” message to the UE.
RRC or MAC signaling is used as configured in 202-203 and as used in 206
The response message includes at least the following.
   the ML-based algorithm ID from 202.
   the ML-based action ID from 206.
In some implementations, the response message can include a validity time/period for the response (ACK or NACK), within which the UE is expected to apply, or not, the action.

At 209, the UE, after receiving the “ML Action ACK” message from its serving gNB, executes the action.
The information from the response message is applied to the corresponding ML-based algorithm and ML-based action.
In some implementations, in which the UE sends an ordered list of preferred actions and the gNB replies with the ID of the best action (from gNB perspective), the UE can use the selected action to tune (e.g., retrain) its own ML-based algorithm. For example, the action selected by the gNB becomes label for the data used as input features (and the pair becomes thus an additional training data point).

In some implementations, at 210 the UE sends an “ML Action Indicator” message to the serving gNB to indicate the estimated local outcome of taking, or not taking, this action.
RRC signaling is used.
The UE estimates the local (UE perceived) impact of the action on the configured KPI(s) from 202-203.

In some implementations, at 211 the gNB receiving an “ML Action Indicator” message stores the indicated impact and potentially also evaluates a global impact factor (e.g., a selected cell-based KPI) taking in consideration the available action indicators from other served UEs.
The gNB processes and stores the received information (historical data) to allow for adjustment of future “ML Action ACK/NACK” messages to the same UE.
   In some implementations, the ‘learned’ impact of the actions can also be used in the configuration at 202-203.
The same additional inputs as 207 may be used.

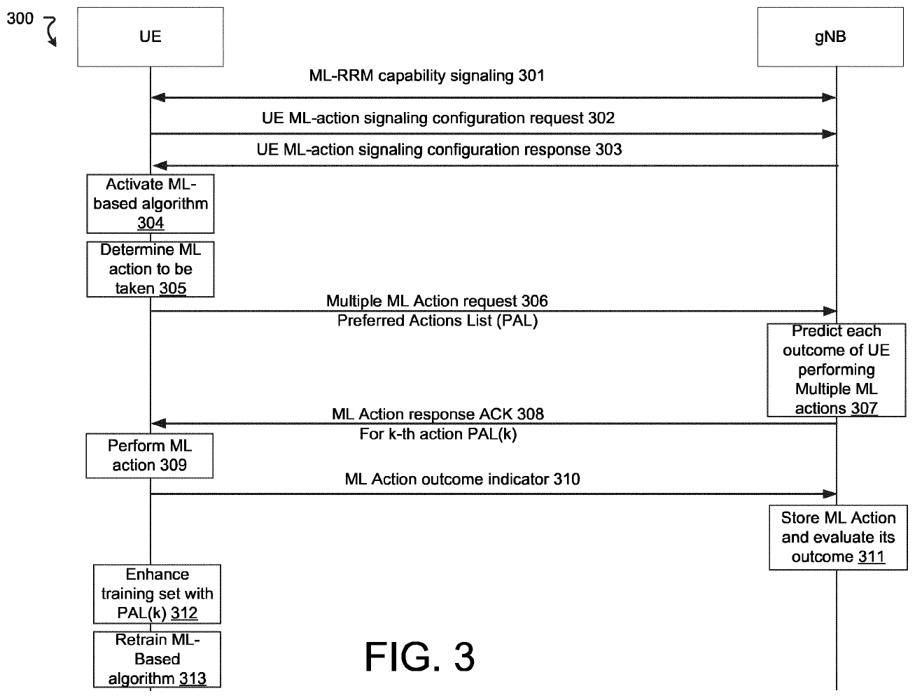

FIG. 3 is a sequence diagram illustrating a process 300 of determining action to take upon execution of machine learning algorithms. Process 300 differs from process 200 in two ways: process 300 allows for multiple possible ML actions to be taken; these are expressed in a preferred actions list (PAL), and process 300 uses the PAL to enhance training sets for the ML-based processes and retrain the ML-based processes using the enhanced training sets.

At 301, in some implementations, The gNB and UE are exchanging messages regarding machine learning radio resource management (RRM) capability signaling.

At 302 the UE requests one or more signaling configurations from the gNB to be used during the execution of one or more ML-based algorithms.
RRC signaling is used.
   After the UE has transitioned from IDLE to CONNECTED mode, in case the UE ML-based algorithm is applied in CONNECTED mode, or
   Before the UE transitioning to IDLE/INACTIVE mode, in case the UE ML-based algorithm is applied in IDLE/INACTIVE mode.
The signaling configuration information indicates for each requested ML-based algorithm, at least the following.
   a ML-based algorithm ID—to be used by the gNB when aggregating information from several UEs and when sending ACK/NACK messages.
      This ID can be an ID of the ML-based algorithm/functionality e.g., HO, beam-selection, PC, etc.
      In some implementations, this ID can also include a version number for a continuously updated model as for federated learning solutions.
      In some implementations, the algorithm ID may designate the range of outputs (and potentially inputs) of the ML algorithm, without disclosing any implementation details.
   selection between the “UE request action permission” or “UE sends action indicator” (i.e., first and second scenarios)—the same ML-based algorithm could be configured for both procedures (different IDs) to allow potential switching at the request of the gNB.
   the signaling channel to be used, or protocol layer to be used e.g., RRC or MAC is selected depending on the time constrains of the action execution, and the expected parameters to be configured (information element IDs, accepted range of values, etc.).
   the set of ML Action IDs, to be used on the configured signaling channels.
   the set of ML Action Outcome IDs corresponding to at least one UE KPI which the UE uses to evaluate the local impact of the ML-based actions e.g., throughput target, throughput with delay constrains, spectral efficiency, energy consumption, etc.

At 303, the UE receives the signaling configuration(s) from the gNB, implicitly indicating the acknowledgment that the UE can start using the corresponding ML-based algorithm(s) to take actions e.g., a radio parameter setting.
RRC signaling is used.
   After the UE has transitioned from IDLE to CONNECTED mode, in case the ML-based algorithm is applied in CONNECTED mode, or
   Before the UE transitioning to IDLE/INACTIVE mode, in case the ML-based algorithm is applied in IDLE/INACTIVE mode.
The UE may apply the received configurations and disable all other ML-based algorithms for which it did not request or receive a configuration.
The configuration message can include a different evaluation KPI than requested by the UE.

At 304, the UE activates the ML algorithm, which produces an output.

At 305, the UE determines actions to be taken based on the output.

At 306, the UE sends a “ML Action Request” message to the serving gNB, including a preferred actions list (PAL).
RRC or MAC signaling is used as configured in 202 and 203.
The message includes at least the following.
   The ML-based algorithm ID from 202.
   The PAL (e.g., increase or decrease of TX power, UE beam selection, etc.) and associated IDs.
The UE, by providing the PAL, allows the gNB to select the best action with regard to network KPI performance.
In some implementations, the ML architecture can be split between the UE and gNB and trained jointly, in that case, some partial outcomes would be sent from the UE to the gNB, the latter being ultimately in charge of generating the best action for each UE.

At 307, the gNB evaluates the potential outcome of each of the requested actions of the PAL taking in consideration the available actions requests/executions from other served UEs, the QoS requirements, traffic conditions (load), UE radio/RF capabilities, etc.
This is understood as ‘admission control’ for UE ML-based actions.
Historical data might be used at gNB side as the labelled data for training and testing.

At 308, the UE receives a respective “ML Action Response ACK” message for each of the actions of the PAL, if that action is evaluated by the gNB to not have any detrimental impact on selected network KPIs (e.g., cell throughput degradation, increase PRB utilisation—can be different from the UE KPIs selected above) then, gNB sends a “ML Action ACK” message to the UE. Otherwise, the gNB sends a “ML Action NACK” message to the UE for that action.
RRC or MAC signaling is used as configured in 302-303 and as used in 306.
The response message includes at least the following.
   the ML-based algorithm ID from 302, or
   the ML-based action ID from 306.
In some implementations, the response message can include a validity time/period for the response (ACK or NACK), within which the UE is expected to apply, or not, the action.

At 309, the UE, after receiving the “ML Action ACK” message from its serving gNB for the k-th action, executes the k-th action (PAL (k)).
The information from the response message is applied to the corresponding ML-based algorithm and ML-based action.
The Stop (NACK) message indicates the UE should not apply the corresponding action until explicitly enabled by the gNB.
In some implementations, the gNB replies with the ID of the best action (from gNB perspective), the UE can use the selected action to tune (e.g., retrain) its own ML-based algorithm. For example, the action selected by the gNB becomes label for the data used as input features (and the pair becomes thus an additional training data point).
When a distributed multi-agent Actor-Critic RL based algorithm is used at the UE and gNB, the network can additionally feedback to the UE RL related parameters/variables, such as the estimated network level reward.

In some implementations, at 310 the UE sends an “ML Action Indicator” message to the serving gNB to indicate the estimated local outcome of taking, or not taking, this action.
RRC signaling is used.
The UE estimates the local (UE perceived) impact of the action on the configured KPI(s) from 202-203.

In some implementations, at 311 the gNB receiving an “ML Action Indicator” message stores the indicated impact and potentially also evaluates a global impact factor (e.g., a selected cell-based KPI) taking in consideration the available action indicators from other served UEs.
The gNB processes and stores the received information (historical data) to allow for adjustment of future “ML Action ACK/NACK” messages to the same UE.
   In some implementations, the ‘learned’ impact of the actions can also be used in the configuration at 202-203.
The same additional inputs as 207 may be used.

At 312, the UE enhances training set(s) using PAL (k). Once a PAL (k) is acknowledged by the network, that becomes a label for the dataset that generated the decision in the first place (i.e., at 305). In other words, the real data and the outcome of the ML block becomes an additional training point, where the label has been vetted by the network. By doing so, the training set (which initially contained only training data generated during a training process) is augmented with training data generated during normal operation (i.e., after ML has been deployed and applied).

At 313, the UE retrains an ML-based algorithm using the enhanced training set(s). By doing so, the ML model learns what the NW preferences are i.e., which action the network will prefer to select from the PAL.

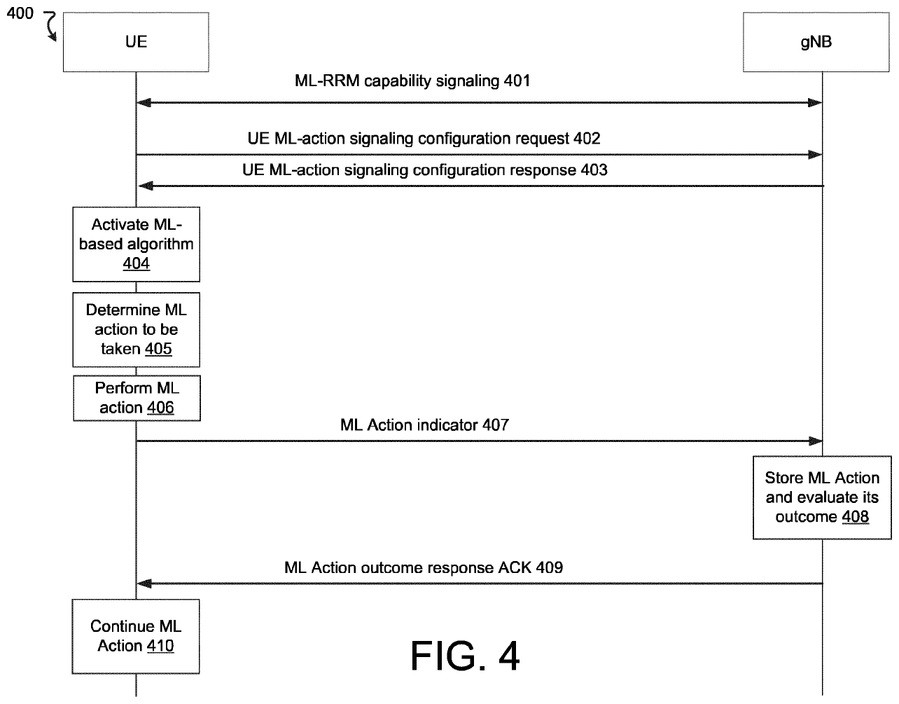

FIG. 4 is a sequence diagram illustrating a process 400 of determining action to take upon execution of a machine learning algorithm, corresponding to the second scenario described above.

At 401, in some implementations, the gNB and UE are exchanging messages regarding machine learning radio resource management (RRM) capability signaling.

At 402 the UE requests one or more signaling configurations from the gNB to be used during the execution of one or more ML-based algorithms.
RRC signaling is used.
   After the UE has transitioned from IDLE to CONNECTED mode, in case the UE ML-based algorithm is applied in CONNECTED mode, or
   Before the UE transitioning to IDLE/INACTIVE mode, in case the UE ML-based algorithm is applied in IDLE/INACTIVE mode.
The signaling configuration information indicates for each requested ML-based algorithm, at least the following.
   a ML-based algorithm ID—to be used by the gNB when aggregating information from several UEs and when sending ACK/NACK messages,
      This ID can be an ID of the ML-based algorithm/functionality e.g., HO, beam-selection, PC, etc.
      In some implementations, this ID can also include a version number for a continuously updated model as for federated learning solutions.
      In some implementations, the algorithm ID may designate the range of outputs (and potentially inputs) of the ML algorithm, without disclosing any implementation details.
   selection between the “UE request action permission” or “UE sends action indicator” (i.e., first and second scenarios)—the same ML-based algorithm could be configured for both procedures (different IDs) to allow potential switching at the request of the gNB,
   the signaling channel to be used, or protocol layer to be used e.g., RRC or MAC is selected depending on the time constrains of the action execution, and the expected parameters to be configured (information element IDs, accepted range of values, etc.).
   the set of ML Action IDs, to be used on the configured signaling channels,
   the set of ML Action Outcome IDs corresponding to at least one UE KPI which the UE uses to evaluate the local impact of the ML-based actions e.g., throughput target, throughput with delay constrains, spectral efficiency, energy consumption, etc.

At 403, the UE receives the signaling configuration(s) from the gNB, implicitly indicating the acknowledgment that the UE can start using the corresponding ML-based algorithm(s) to take actions e.g., a radio parameter setting.
RRC signaling is used.
   After the UE has transitioned from IDLE to CONNECTED mode, in case the ML-based algorithm is applied in CONNECTED mode, or
   Before the UE transitioning to IDLE/INACTIVE mode, in case the ML-based algorithm is applied in IDLE/INACTIVE mode.
The UE may apply the received configurations and disable all other ML-based algorithms for which it did not request or receive a configuration.
The configuration message can include a different evaluation KPI than requested by the UE.

At 404, the UE activates the ML algorithm, which produces an output.

At 405, the UE determines an action to be taken based on the output.

At 406, the UE performs the action, without first asking permission of the gNB as in scenario 1.

At 407, the UE sends a “ML Action Indicator” message to the serving gNB, including indication of the estimated local outcome of taking the determined action.
RRC signaling is used.
The message includes at least the following.
   The ML-based algorithm ID from 402.
   An action ID.
   An action outcome ID.
   The UE could be able to learn from its actions and interaction with the RAN, and provide this as additional ‘post-action’ information.

At 408, the gNB evaluates the potential outcome of the requested action taking in consideration the available actions requests/executions from other served UEs, the QoS requirements, traffic conditions (load), UE radio/RF capabilities, etc.
In some implementations, when the action impact is consistently detrimental to the gNB, the gNB can indicate switching the UE to use the method from scenario 1.
In some implementations, a validity time/period is provided for the response (ACK or NACK), within which the UE is expected to apply, or not, the action.

At 409, the UE receives a “ML Action Impact ACK/NACK” message to the UE indicating (at least) to Continue (ACK) or to Stop (NACK) taking the actions.
RRC signaling is used.
The Continue a (ACK) message indicates the UE continues to use the configured ML-based algorithm and apply the action which has been ACKed. The signaling from step 6 of this action could be relaxed, such that it happens with higher periodicity.
The Stop (NACK) message indicates the UE should not apply the corresponding action until explicitly enabled by the gNB.
In some implementations, when a distributed multi-agent Actor-Critic RL based algorithm is used at the UE and gNB, the network can additionally feedback to the UE RL related parameters/variables, such as the estimated network level reward.
In some implementations, the gNB indicates switching the UE to use the method of scenario 1.

At 410, the UE which receives the “ML Action Impact ACK/NACK” message from its serving gNB, will (at least) Continue (ACK) or Stop (NACK) taking these actions.
When Continue a (ACK) message is received, the UE continues to use the configured ML-based algorithm and apply the action which has been ACKed. The signaling from step 6 of this action could be relaxed, such that it happens with higher periodicity.
When a Stop (NACK) message is received, the UE should not apply the corresponding action until explicitly enabled by the gNB.
In some implementations, when a distributed multi-agent Actor-Critic RL based algorithm is used at the UE and gNB, the network can additionally provide to the UE RL related parameters/variables, such as the estimated network level reward.
In some implementations, the gNB indicates switching the UE to use the method of scenario 1.

In both scenarios 1 and 2, the following are specifics for cases when the UE ML-based algorithm is applied in RRC IDLE/INACTIVE mode.
The RRC CONNECTED mode configuration(s) are stored and used separately, and they might likely apply to different ML-based algorithms than used in RRC IDLE/INACTIVE mode.
The configuration information from 402-403 might be re-used whenever the UE enters RRC IDLE/INACTIVE mode.
The UL UE RRC messages can be sent in similar way as the Tracking Area Update messages.
The DL gNB RRC messages are not employed and PDCCH or broadcast information is used to convey the “ML Action ACK/NACK” or “ML Action Impact ACK/NACK” messages (e.g., simplified to 1-bit).

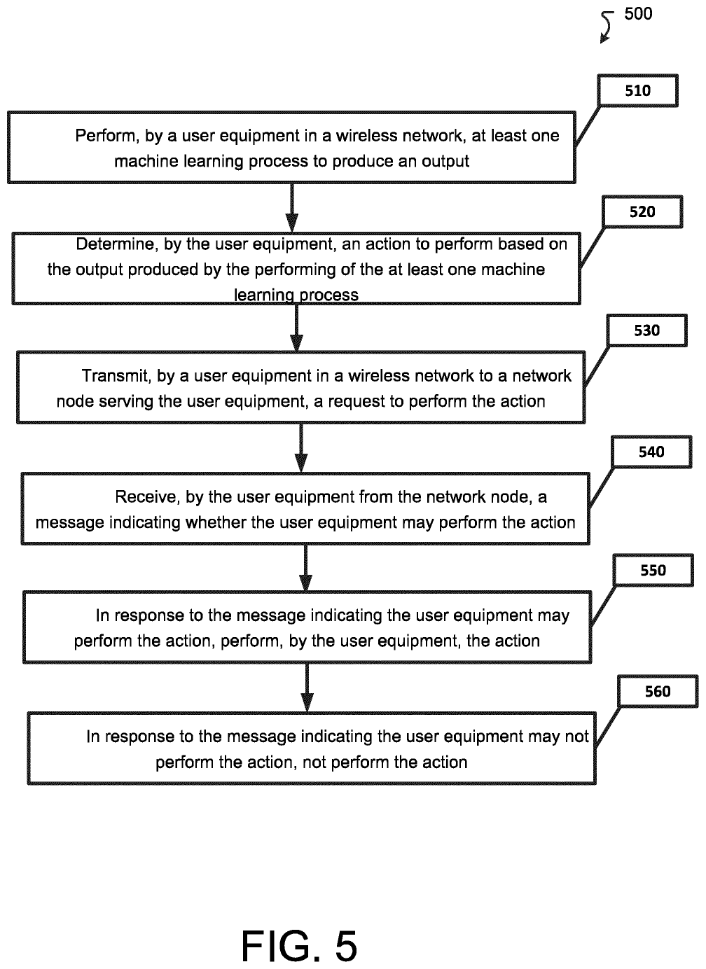

Example 1-1: FIG. 5 is a flow chart illustrating a process 500 of determining action to take upon execution of a machine learning algorithm. Operation 510 includes performing, by a user equipment in a wireless network, at least one machine learning process to produce an output. Operation 520 includes determining, by the user equipment, an action to perform based on the output produced by the performing of the at least one machine learning process. Operation 530 includes transmitting, by a user equipment in a wireless network to a network node serving the user equipment, a request to perform the action. Operation 540 includes receiving, by the user equipment from the network node, a message indicating whether the user equipment may perform the operation 550 includes, in response to the message indicating the user equipment may perform the action, performing, by the user equipment, the action. Operation 560 includes, in response to the message indicating the user equipment may not perform the action, not performing the action.

Example 1-2: According to an example implementation of Example 1-1, further comprising transmitting a request for at least one machine learning process signaling configuration to be used during performance of the at least one machine learning-based process; and receive the at least one machine learning action signaling configurations.

Example 1-3: According to an example implementation of any of Examples 1-1 and 1-2, wherein the request for at least one machine learning action signaling configurations is transmitted via radio resource control signaling.

Example 1-4: According to an example implementation of Example 1-3, wherein the user equipment performs the at least one machine learning process in a CONNECTED state, and wherein the radio resource control signaling is used to transmit in response to the user equipment transitioning from an IDLE state to the CONNECTED state.

Example 1-5: According to an example implementation of Examples 1-3 to 1-4, wherein the user equipment performs the at least one machine learning process in an IDLE or INACTIVE state, and wherein the radio resource control signaling is used to transmit in response to the user equipment transitioning from a CONNECTED state to the IDLE or INACTIVE state.

Example 1-6: According to an example implementation of Examples 1-2 to 1-5, further comprising receiving, from the network node in response to the request for at least one machine learning process signaling configuration to be used during performance of the at least one machine learning process, the at least one machine learning process signaling configuration, indicating that the user equipment may perform the at least one machine learning process.

Example 1-7: According to an example implementation of Examples 1-5 to 1-6, further comprising transmitting, to the network node, a message indicating an estimate of an outcome of performing the action.

Example 1-8: According to an example implementation of any of Examples 1-1 to 1-7, wherein each of the at least one machine learning process has a respective machine learning process identifier, and wherein the message indicating whether the user equipment may perform the action includes a reference to the respective machine learning process identifier producing the action.

Example 1-9: According to an example implementation of Example 1-8, wherein the respective machine learning process identifier includes a version number of the at least one machine learning process.

Example 1-10: According to an example implementation of Examples 1-8 to 1-9, wherein the respective machine learning process identifier includes a range of outputs of the at least one machine learning process.

Example 1-11: According to an example implementation of Examples 1-1 to 1-10, further comprising measuring the outcome of the at least one machine learning process to produce a process measurement.

Example 1-12: According to an example implementation of Examples 1-10 to 1-11, wherein the process measurement corresponds to a key performance indicator (KPI), and wherein the method further comprises assigning an outcome identifier to the KPI, the outcome identifier identifying the outcome, and wherein the respective machine learning process identifier includes the outcome identifier.

Example 1-13: According to an example implementation of any of Examples 1-1 to 1-12, wherein the request to perform the action includes identifiers of a plurality of machine learning processes, the identifiers being arranged in order of a value of a key performance indicator (KPI).

Example 1-14: According to an example implementation of Example 1-13, wherein the at least one machine learning process signaling configurations includes a message indicating which of the plurality of machine learning processes the user equipment may perform.

Example 1-15: According to an example implementation of Examples 1-1 to 1-14, wherein the at least one machine learning process produces a plurality of actions, and wherein the request to perform the action includes respective identifiers of the plurality of actions.

Example 1-16: An apparatus comprising means for performing a method of any of Examples 1-1 to 1-15.

Example 1-17: A computer program product including a non-transitory computer-readable storage medium and storing executable code that, when executed by at least one data processing apparatus, is configured to cause the at least one data processing apparatus to perform a method of any of Examples 1-1 to 1-16.

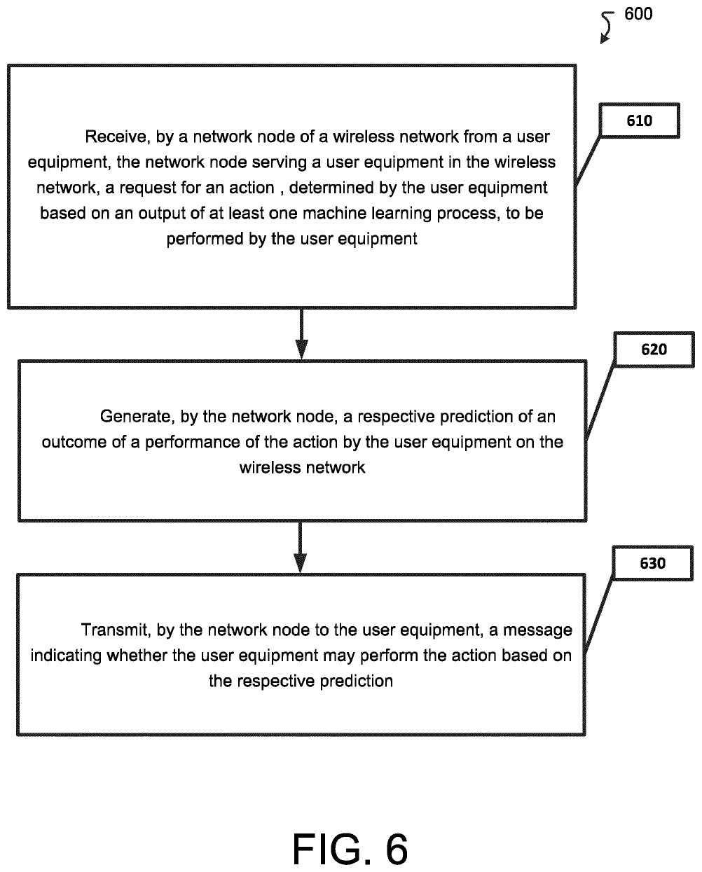

Example 2-1: FIG. 6 is a flow chart illustrating a process 600 of determining action to take upon execution of a machine learning algorithm. Operation 610 includes receiving, by a network node of a wireless network from a user equipment, the network node serving a user equipment in the wireless network, a request for an action, determined by the user equipment based on an output of at least one machine learning process, to be performed by the user equipment. Operation 620 includes generating, by the network node, a respective prediction of an outcome of a performance of the action by the user equipment on the wireless network. Operation 630 includes transmitting, by the network node to the user equipment, a message indicating whether the user equipment may perform the action based on the respective prediction.

Example 2-2: According to an example implementation of Example 2-1, wherein the request includes a respective identifier for the at least one machine learning process, and wherein the message includes a respective identifier for the respective prediction of the outcome of the performance of the action.

Example 2-3: According to an example implementation of Examples 2-1 or 2-2, wherein a generation of the respective prediction of the outcome of the performance of the action is based on at least one of quality of service requirements, traffic conditions, user equipment radio capabilities, or requests from other user equipments in the wireless network.

Example 2-4: According to an example implementation of Example 2-3, wherein the message indicates the user equipment may perform the action, and wherein the method further comprises receiving, from the user equipment, a message indicating an estimate of an outcome of performing the action.

Example 2-5: According to an example implementation of Example 2-4, further comprising storing the estimate of the outcome of taking the at least one machine learning process, and evaluating an impact of the estimate of the outcome of taking the at least one machine learning process.

Example 2-6: An apparatus comprising means for performing a method of Example 2-1.

Example 2-7: A computer program product including a non-transitory computer-readable storage medium and storing executable code that, when executed by at least one data processing apparatus, is configured to cause the at least one data processing apparatus to perform a method of Example 2-1.

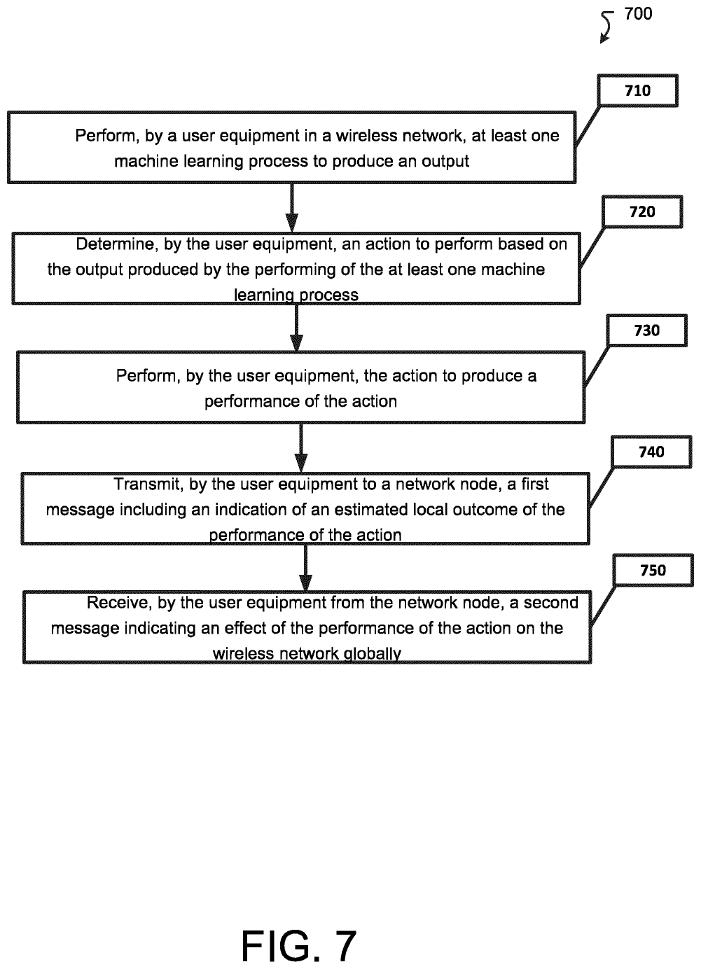

Example 3-1: FIG. 7 is a flow chart illustrating a process 700 of determining action to take upon execution of a machine learning algorithm. Operation 710 includes performing, by a user equipment in a wireless network, at least one machine learning process to produce an output. Operation 720 includes determining, by the user equipment, an action to perform based on the output produced by the performing of the at least one machine learning process. Operation 730 includes performing, by the user equipment, the action to produce a performance of the action. Operation 740 includes transmitting, by a user equipment to a network node, a first message including an indication of an estimated local outcome of the performance of the action. Operation 750 includes receiving, by the user equipment from the network node, a second message indicating an effect of the action on the wireless network globally.

Example 3-2: According to an example implementation of Example 3-1, wherein the second message indicates that the user equipment should not continue performing the action, and wherein the method further comprises ceasing performing the action.

Example 3-3: According to an example implementation of Example 3-2, wherein the second message further indicates that the user equipment is to transmit, to the network node serving the user equipment, a request to perform the action prior to a subsequent performance of the action.

Example 3-4: An apparatus comprising means for performing a method of Example 3-1.

Example 3-5: A computer program product including a non-transitory computer-readable storage medium and storing executable code that, when executed by at least one data processing apparatus, is configured to cause the at least one data processing apparatus to perform a method of Example 3-1.

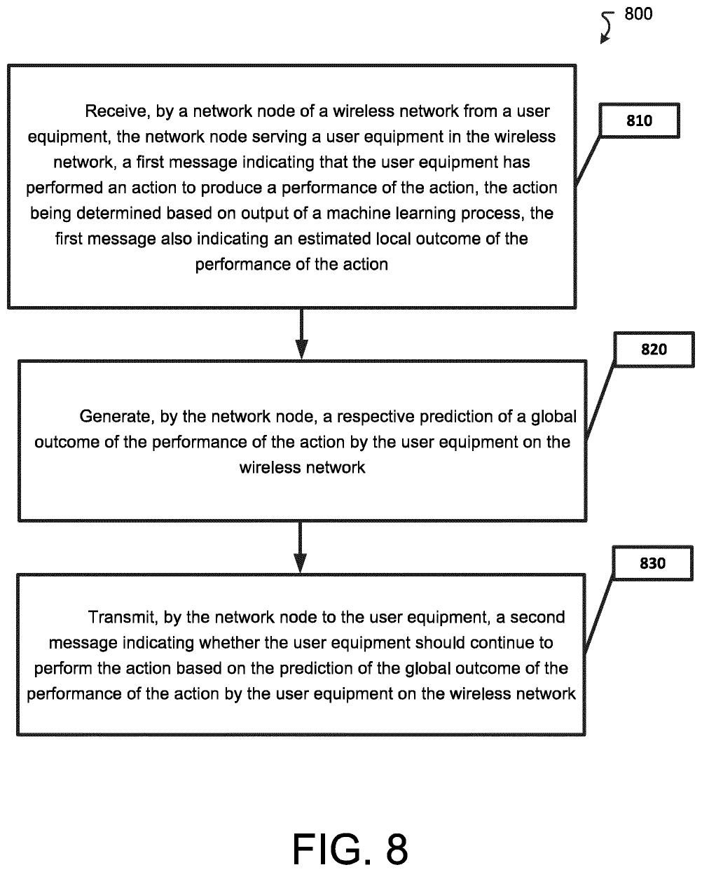

Example 4-1: FIG. 8 is a flow chart illustrating a process 800 of determining action to take upon execution of a machine learning algorithm. Operation 810 includes receiving, by a network node of a wireless network from a user equipment, the network node serving a user equipment in the wireless network, a first message indicating that the user equipment has performed an action to produce a performance of the action, the action being determined based on output of a machine learning process, the first message also indicating an estimated local outcome of the performance of the action. Operation 820 includes generating, by the network node, a respective prediction of a global outcome of the performance of the action by the user equipment on the wireless network. Operation 830 includes transmitting, by the network node to the user equipment, a second message indicating whether the user equipment should continue to perform the action based on the prediction of the global outcome of the performance of the action by the user equipment on the wireless network.

Example 4-2: An apparatus comprising means for performing a method of Example 4-1.

Example 4-3: A computer program product including a non-transitory computer-readable storage medium and storing executable code that, when executed by at least one data processing apparatus, is configured to cause the at least one data processing apparatus to perform a method of Example 4-1.

The following example is a use case for scenario 1. The process defined in scenario 1 is applicable to address the UE UL TPC parameters optimization problem, where the objective is to determine an optimal transmit power value per UE such that the UL/sidelink UE throughput is maximized without significant impact on the overall UL cell performance. Reinforcement learning can be one of the preferred ML-based algorithms, and the RL agent is assumed to be deployed at the UE side to adjust the UE UL (or sidelink) transmit power based on local radio conditions. These power adjustments are assumed to be combined with the normal UL OLPC and UL CLPC mechanisms.

In this example, in 202-203, 302-303, or 402-403, the gNB and UE agree on the type of ML-based algorithm: RL-based using as input UE local measurements (RSRP) and antenna panel or beam selection information. For example, the RL algorithm is used to determine to apply three possible actions: ‘Power increase 1 dB’ (ID=0), ‘Power decrease 1 dB’ (ID=1), ‘No Power adjustment’ (ID=2).

Assuming scenario 1 is used in this example.
The UE will autonomously determine a suitable UL transmit power adjustment (combined with OLPC and CLPC), and informs the serving gNB about its ML Action ID without applying the action.
The gNB uses the information on the potential transmit power level of the UE and estimate the cell UL performance (global impact) using also knowledge from all other UEs served.
If, the gNB does not estimate any significant degradation from the candidate UE ML Action, then it sends an ML Action ACK response to the UE.
The UE executes the action and adjust its transmit power accordingly.
The serving gNB can evaluate the global impact of the UE power adjustment action, thus it can also tune the estimation algorithm used for deciding on the future similar ML Actions (same UE or other UEs.

Variations on the above example include the use of scenario 2, and/or use of other types of UE ML algorithms (CNN/DNN/GAN/RNN).

The following example is a use case for scenario 2. The process defined in scenario 2 is applicable to address the UE antenna panel selection optimization problem, where the objective is to determine an optimal transmission/reception per UE such that its link throughput is maximized. Reinforcement learning can be one of the preferred ML-based algorithms. An RL agent is assumed to be deployed at the UE side to adjust the UE antenna panel (or beam) to be used based on local radio conditions. Another RL agent is deployed at the gNB side to track the global performance in the cell, related to UE panel selections. This ML architecture allows for collaboration with the gNB and finetuning of the UE antenna selection, while maintaining UE autonomy.

Assuming scenario 2 is used in this example.
The UE will autonomously determine antenna panel to use, switches to the selected antenna panel (ML Action) and informs the serving gNB about its ML Action ID.
The gNB uses the information on the selected antenna panel and, for example, evaluates the cell UL interference (global impact) using also knowledge from all other UEs served.
If, the gNB does not evaluate any significant degradation from the taken UE ML Action, then it sends an ML Action Impact ACK response to the UE, including an indication of the cell level reward metric.
   The UE continues to use the antenna panel selection algorithm, uses the cell level reward metric indication to adjust its own local reward function, and informs the gNB about its actions (potentially with higher periodicity to reduce signaling load).
If/when the gNB evaluates a potential degradation of the UL performance in the cell due to the UE antenna panel selection, then it sends an ML Action Impact NACK response to the UE.
   The UE stops taking the action which has been ‘rejected’ by the serving gNB.

Variations on the above example include the use of scenario 1, and/or use of other types of UE ML algorithms (CNN/DNN/GAN/RNN).

### LIST OF EXAMPLE ABBREVIATIONS

BLER block error rate
BS basestation, synonym for 5G gNB
CU central unit (5G CU-gNB)
DNN deep neural network (5G DU-gNB)
DU distributed unit
KPI key performance indicator
LA link adaptation
MCS modulation and coding scheme
ML machine learning
NN neural network
PC power control
PDU protocol data unit
RB resource block
RL reinforcement learning
RSRP reference signal receive power
SE spectral efficiency
TP throughput
UL uplink

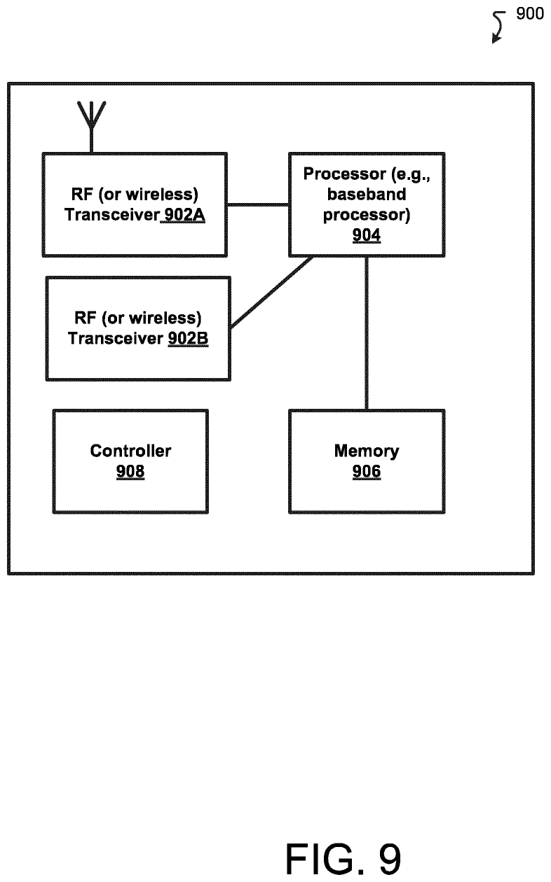

FIG. 9 is a block diagram of a wireless station (e.g., AP, BS, e/gNB, NB-IoT UE, UE or user device) 900 according to an example implementation. The wireless station 900 may include, for example, one or multiple RF (radio frequency) or wireless transceivers 902A, 902B, where each wireless transceiver includes a transmitter to transmit signals (or data) and a receiver to receive signals (or data). The wireless station also includes a processor or control unit/entity (controller) 904 to execute instructions or software and control transmission and receptions of signals, and a memory 906 to store data and/or instructions.

Processor 904 may also make decisions or determinations, generate slots, subframes, packets or messages for transmission, decode received slots, subframes, packets or messages for further processing, and other tasks or functions described herein. Processor 904, which may be a baseband processor, for example, may generate messages, packets, frames or other signals for transmission via wireless transceiver 902 (902A or 902B). Processor 904 may control transmission of signals or messages over a wireless network, and may control the reception of signals or messages, etc., via a wireless network (e.g., after being down-converted by wireless transceiver 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, referring to FIG. 9, a controller (or processor) 908 may execute software and instructions, and may provide overall control for the station 900, and may provide control for other systems not shown in FIG. 9 such as controlling input/output devices (e.g., display, keypad), and/or may execute software for one or more applications that may be provided on wireless station 900, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example implementation, RF or wireless transceiver(s) 902A/902B may receive signals or data and/or transmit or send signals or data. Processor 904 (and possibly transceivers 902A/902B) may control the RF or wireless transceiver 902A or 902B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1-30. (canceled)

31. An apparatus, comprising:
at least one processor; and
at least one memory including computer program code;
the at least one memory and the computer program code configured to cause the apparatus at least to:
perform at least one machine learning process to produce an output;
determine an action to perform based on the output produced by the performing of the at least one machine learning process;
transmit, to a network node serving the apparatus, a request to perform the action;
receive, from the network node, a message indicating whether the apparatus may perform the action;
in response to the message indicating the apparatus may perform the action, perform the action; and
in response to the message indicating the apparatus may not perform the action, not perform the action.

32. The apparatus as in claim 31, wherein the at least one memory and the computer program code are further configured to cause the apparatus at least to:
transmit a request for at least one machine learning process signaling configuration to be used during performance of the at least one machine learning-based process; and
receive the at least one machine learning action signaling configuration.

33. The apparatus as in claim 32, wherein the at least one memory and the computer program code are further configured to cause the apparatus at least to:
receive, from the network node in response to the request for at least one machine learning process signaling configuration to be used during performance of the at least one machine learning process, the at least one machine learning process signaling configuration, indicating that the apparatus may perform the at least one machine learning process.

34. The apparatus as in claim 31, wherein the at least one memory and the computer program code are further configured to cause the apparatus at least to:
transmit, to the network node, a message indicating an estimate of an outcome of performing the action.

35. The apparatus as in claim 31, wherein each of the at least one machine learning process has a respective machine learning process identifier;
wherein the message indicating whether the apparatus may perform the action includes a reference to the respective machine learning process identifier producing the action.

36. The apparatus as in claim 35, wherein the respective machine learning process identifier includes a version number of the at least one machine learning process.

37. The apparatus as in claim 35, wherein the respective machine learning process identifier includes a range of outputs of the at least one machine learning process.

38. The apparatus as in claim 31, wherein the at least one memory and the computer program code are further configured to cause the apparatus at least to:
measuring the output of the at least one machine learning process to produce a process measurement.

39. The apparatus as in claim 38, wherein each of the at least one machine learning process has a respective machine learning process identifier;
wherein the process measurement corresponds to a key performance indicator (KPI), and
wherein the at least one memory and the computer program code are further configured to cause the apparatus at least to:
assign an outcome identifier to the KPI, the outcome identifier identifying the outcome, and
wherein the respective machine learning process identifier includes the outcome identifier.

40. The apparatus as in claim 31, wherein the request to perform the action includes identifiers of a plurality of machine learning processes, the identifiers being arranged in order of a value of a key performance indicator.

41. The apparatus as in claim 40, wherein the at least one machine learning process signaling configurations includes a message indicating which of the plurality of machine learning processes the apparatus may perform.

42. The apparatus as in claim 31, wherein the at least one machine learning process produces a plurality of actions, and
wherein the request to perform the action includes respective identifiers of the plurality of actions.

43. An apparatus, comprising:
at least one processor; and
at least one memory including computer program code;
the at least one memory and the computer program code configured to cause the apparatus at least to:
receive, from a user equipment served by the apparatus in a wireless network, a request for an action, determined by the user equipment based on an output of at least one machine learning process, to be performed by the user equipment;
generate a respective prediction of an outcome of a performance of the action by the user equipment on the wireless network; and
transmit, to the user equipment, a message indicating whether the user equipment may perform the action based on the respective prediction.

44. The apparatus as in claim 43, wherein the request includes a respective identifier for the at least one machine learning process, and
wherein the message includes a respective identifier for the respective prediction of the outcome of the performance of the action.

45. The apparatus as in claim 43, wherein a generation of the respective prediction of the outcome of the performance of the action is based on at least one of quality of service requirements, traffic conditions, user equipment radio capabilities, or requests from other user equipments in the wireless network.

46. The apparatus as in claim 45, wherein the message indicates the user equipment may perform the action, and
wherein the at least one memory and the computer program code are further configured to cause the apparatus at least to:
receive, from the user equipment, a message indicating an estimate of an outcome of performing the action.

47. The apparatus as in claim 46, wherein the at least one memory and the computer program code are further configured to cause the apparatus at least to:
store the estimate of the outcome of taking the at least one machine learning process; and
evaluate an impact of the estimate of the outcome of taking the at least one machine learning process.

48. An apparatus, comprising:
at least one processor; and
at least one memory including computer program code;
the at least one memory and the computer program code configured to cause the apparatus at least to:
perform at least one machine learning process to produce an output;
determine an action to perform based on the output produced by the performing of the at least one machine learning process;
perform the action to produce a performance of the action;
transmit, to a network node serving the apparatus, a first message including an indication of an estimated local outcome of the performance of the action; and
receive, from the network node, a second message indicating an effect of the performance of the action on the wireless network globally.

49. The apparatus as in claim 48, wherein the second message indicates that the apparatus should not continue performing the action, and
wherein the at least one memory and the computer program code is further configured to cause the apparatus at least to:
cease performing the action.

50. The apparatus as in claim 49, wherein the second message further indicates that the apparatus is to transmit, to the network node, a request to perform the action prior to a subsequent performance of the action.
